(19) United States
(12) Patent Application Publication
(10) Pub. No.: US 2019/0041994 A1
(43) Pub. Date: Feb. 7, 2019

(54) CONTACTLESS GESTURE RECOGNITION SYSTEM AND METHOD THEREOF

(71) Applicant: CENTER FOR INTEGRATED SMART SENSORS FOUNDATION, Yuseong-gu (KR)

(72) Inventor: Kyung Il Cho, Yuseong-gu (KR)

(73) Assignee: CENTER FOR INTEGRATED SMART SENSORS FOUNDATION, Yuseong-gu (KR)

(21) Appl. No.: 16/053,500

(22) Filed: Aug. 2, 2018

(30) Foreign Application Priority Data
Aug. 4, 2017 (KR) 10-2017-0098867

(51) Int. Cl. G06F 3/01

(52) U.S. Cl. CPC G06F 3/017

(57) ABSTRACT

The inventive concept relates to a contactless gesture recognition system that senses a contactless gesture operation by using a contactless ultrasonic switch of a single channel and distinguishes a lateral mode and a cover mode according to the sensed contactless gesture operation to provide a contactless interface function, and a method thereof, and includes an operation sensing unit sensing a contactless gesture operation by using an ultrasonic sensor of a single channel, a mode distinguishing unit analyzing a detection signal sensed from the ultrasonic sensor of the single channel by the contactless gesture operation to distinguish a lateral mode and a cover mode, and a control unit controlling a contactless interface function corresponding to each of the lateral mode and the cover mode.

### CROSS-REFERENCE TO RELATED APPLICATIONS

A claim for priority under 35 U.S.C. § 119 is made to Korean Patent Application No. 10-2017-0098867 filed on Aug. 4, 2017, in the Korean Intellectual Property Office, the entire contents of which are hereby incorporated by reference.

### BACKGROUND

Embodiments of the inventive concepts described herein relate to a contactless gesture recognition system and a method thereof, and more particularly, relate to a technology that senses a contactless gesture operation by using a contactless ultrasonic switch of a single channel and distinguishes a lateral mode and a cover mode according to the sensed contactless gesture operation to provide a contactless interface function.

A graphic user interface is an interface that allows a device to be controlled primarily by an interface, instead of a string. For example, the graphic user interface controls an operating system or an application by selecting or operating a cursor, an icon, a folder, a menu, a window, a screen scroll, zoom-in/zoom-out, a character, or the like by using a mouse, a joystick, a screen touch, or a touch pad.

With the advent of the windows operating system, the graphical user interface has been introduced into computing devices and popularized. Afterwards, a mobile device such as a smartphone and a smart pad is getting popular, and it is increasingly popular to control devices through a screen touch interface.

A contact user interface is a touch-type user interface that manipulates a mouse, moves a character with a joystick, or touches a screen or a touch pad with a user's finger. Accordingly, compared with the contactless user interface, which allows the user to control a device by moving his/her hand freely in the air, the contact user interface is less convenient or less functional.

That is, if the device can recognize the direction of movement of the user's hand, the speed of the hand, the tilting direction of the hand, the tilting position of the hand, the tilting angle of the hand, the tilting speed of the hand, and the proximity to interface means while the user's hands moves as freely as possible, the convenience and functionality of the contactless user interface may be excellent.

In recent years, there has been an increasing interest in technologies for applying such contactless user interfaces.

However, a technology for providing an existing contactless user interface has a limit to provide a contactless user interface function by sensing the user's finger motion (operation) or to provide a contactless user interface function using a motion sensor of a dual channel. Furthermore, the technology for providing the existing contactless user interface has a limit in a field to which such as a terminal device, a device, a large screen, or the like is applied.

### Patent Documents

Korean Registration Patent No. 10-1196291 (registered on Oct. 25, 2012), “TERMINAL THAT RECOGNIZES MOVEMENT OF FINGER AND PROVIDES 3D INTERFACE AND METHOD THEREOF”.

Korean Registration Patent No. 10-1194883 (registered on Oct. 19, 2012), “CONTACTLESS SCREEN CONTROL SYSTEM AND CONTACTLESS SCREEN CONTROL METHOD IN SYSTEM”

### SUMMARY

Embodiments of the inventive concepts provide a technology to sense various motions of a user by using a contactless ultrasonic switch of a single channel and to control various interface functions corresponding to the sensing operation.

Embodiments of the inventive concepts provide a technology to provide a contactless interface function according to a contactless gesture operation, which is applied to an auto faucet, an electronic door lock, an Internet of things (IoT) device, a personal computer (PC) mouse, a smart refrigerator, a mobile device, and an elevator switch.

One aspect of embodiments of the inventive concept is directed to provide a contactless gesture recognition system recognizing a 3-dimensional (3D) gesture that includes an operation sensing unit sensing a contactless gesture operation by using an ultrasonic sensor of a single channel (1 channel), a mode distinguishing unit analyzing a detection signal sensed from the ultrasonic sensor of the single channel by the contactless gesture operation to distinguish a lateral mode and a cover mode, and a control unit controlling a contactless interface function corresponding to each of the lateral mode and the cover mode.

The ultrasonic sensor of the single channel includes an ultrasonic sensor including 1 channel transmission and 1 channel reception, in which transmission and reception are separated, or an ultrasonic sensor including 1 channel transmission and reception, in which the transmission and the reception are coupled.

The operation sensing unit activates the ultrasonic sensor of the single channel to sense the contactless gesture operation after recognizing a user's proximity by using a low power passive infrared ray (PIR) sensor.

The operation sensing unit senses the contactless gesture operation of a lateral motion, a lateral repeat motion, and a distance motion based on succession and disconnection of a beam irradiated from the ultrasonic sensor of the single channel.

The mode distinguishing unit includes a signal sensing module sensing a signal change of the detection signal generated by the contactless gesture operation and a first mode determination module determining the lateral mode and the cover mode based on a preset setting fixed value and a vibration graph change indicating the signal change.

The first mode determination module determines the lateral mode according to the contactless gesture operation of a lateral motion or the cover mode according to the contactless gesture operation of a distance motion, based on the setting fixed value and whether a falling peak generated depending on the signal change is repeated.

The mode distinguishing unit includes a signal sensing module sensing a signal change of the detection signal generated by the contactless gesture operation, a peak area calculation module calculating an area of a falling peak according to the signal change, and a second mode determination module comparing a value of the calculated area with a preset critical value to determine the lateral mode and the cover mode.

The signal sensing module senses the signal change of an occurrence of the falling peak with time, the number of falling peaks, and the area, based on succession and disconnection of a beam, which is irradiated from the ultrasonic sensor of the single channel, by the contactless gesture operation.

The signal sensing module senses the single falling peak according to the contactless gesture operation of a lateral motion and a distance motion and senses the plurality of falling peaks according to the contactless gesture operation of a lateral repeat motion.

The peak area calculation module calculates the area of the falling peak for the sensed single falling peak by multiplying a sample period of the detection signal and a distance, to distinguish the lateral motion and the distance motion according to the sensed single falling peak.

The second mode determination module determines the lateral mode according to the contactless gesture operation of the lateral motion when the value of the calculated area is less than the preset critical value, and determines the cover mode according to the contactless gesture operation of the distance motion when the value of the calculated area is greater than the preset critical value.

The control unit controls the contactless interface function of a mode conversion corresponding to the lateral mode and controls the contactless interface function of amount adjustment corresponding to the cover mode.

The control unit controls a first mode determination module of the mode distinguishing unit that determines a mode by using a vibration graph change or controls a second mode determination module of the mode distinguishing unit that determines a mode by using a mode algorithm, based on a signal change sensed from the detection signal.

The contactless gesture recognition system includes a low power Piezo Micromachined Ultrasonic Transducer (pMUT) ultrasound for an ultra-small size and low power, at mobile installation.

The contactless gesture recognition system is applied to at least one of an auto faucet, an electronic door lock, an Internet of Things (IoT) device, a personal computer (PC) mouse, a smart refrigerator, a mobile and a switch to provide the contactless interface function.

Another aspect of embodiments of the inventive concept is directed to provide an operation method of a contactless gesture recognition system recognizing a 3D gesture that includes sensing a contactless gesture operation by using an ultrasonic sensor of a single channel (1 channel), analyzing a detection signal sensed from the ultrasonic sensor of the single channel by the contactless gesture operation to distinguish a lateral mode and a cover mode, and controlling a contactless interface function corresponding to each of the lateral mode and the cover mode.

The distinguishing of the lateral mode and the cover mode includes sensing a signal change of the detection signal generated by the contactless gesture operation and determining the lateral mode and the cover mode based on a preset setting fixed value and a vibration graph change indicating the signal change.

The distinguishing of the lateral mode and the cover mode includes sensing a signal change of the detection signal generated by the contactless gesture operation, calculating an area of a falling peak according to the signal change, and determining the lateral mode when a value of the calculated area is less than a preset critical value or determining the cover mode when the value of the calculated area is greater than the preset critical value.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 illustrates a block diagram of a detailed configuration of a contactless gesture recognition system, according to an embodiment of the inventive concept;

FIG. 2 illustrates a block diagram of a detailed configuration of a mode distinguishing unit, according to an embodiment of the inventive concept;

FIG. 3 is a view for describing an example of a contactless gesture operation, according to an embodiment of the inventive concept;

FIG. 4 is a view for describing an example to distinguish a lateral motion and a distance motion based on a signal change, according to an embodiment of the inventive concept;

FIG. 5 is a view for describing an example to distinguishing a lateral motion and a lateral repeat motion based on a signal change, according to an embodiment of the inventive concept;

FIGS. 6A and 6B are views for describing an example to distinguish a lateral motion and a distance motion by calculating an area of a falling peak, according to an embodiment of the inventive concept;

FIG. 7 illustrates an example of decoupling according to a contactless gesture operation, according to an embodiment of the inventive concept;

FIGS. 8 to 10 illustrate examples of a contactless interface function; and

FIGS. 11 to 13 illustrate flowcharts of a contactless gesture recognizing method, according to an embodiment of the inventive concept.

### DETAILED DESCRIPTION

Hereinafter, exemplary embodiments of the inventive concept will be described in detail with reference to the accompanying drawings. However, the inventive concept is neither limited nor restricted by the embodiments. Further, the same reference numerals in the drawings denote the same members.

Furthermore, the terminologies used herein are used to properly express the embodiments of the inventive concept, and may be changed according to the intentions of the user or the manager or the custom in the field to which the inventive concept pertains. Therefore, definition of the terms should be made according to the overall disclosure set forth herein.

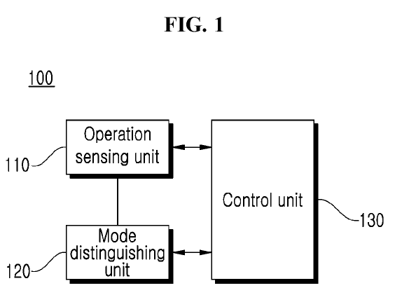

FIG. 1 illustrates a block diagram of a detailed configuration of a contactless gesture recognition system, according to an embodiment of the inventive concept.

Referring to FIG. 1, a contactless gesture recognition system 100 according to an embodiment of the inventive concept senses a contactless gesture operation by using an ultrasonic sensor of a single channel and controls a contactless interface function for each mode according to the contactless gesture operation.

To this end, the contactless gesture recognition system 100 according to an embodiment of the inventive concept includes an operation sensing unit 110, a mode distinguishing unit 120, and a control unit 130.

The operation sensing unit 110 senses the contactless gesture operation by using the ultrasonic sensor of the single channel.

At this time, the ultrasonic sensor of the single channel may be an ultrasonic switch of a contactless single channel (1 channel), and may be an ultrasonic sensor including 1 channel transmission and 1 channel reception, in which transmission and reception are separated from each other, or an ultrasonic sensor including 1 channel transmission and reception, in which transmission and reception are coupled to each other.

The operation sensing unit 110 may sense a contactless gesture operation of a lateral motion, a lateral repeat motion, and a distance motion based on the succession and disconnection of the beam irradiated from the ultrasonic sensor of the single channel.

In detail, the ultrasonic sensor of the single channel irradiates a constant beam using a single channel. At this time, the operation sensing unit 110 may sense the disconnection caused by a user's contactless gesture operation in a continuously irradiated beam, and may sense the lateral motion, the lateral repeat motion, and the distance motion from the signal intensity or the disconnection of the beam with time.

For example, in the case where the user's hand moves from the left of the beam to the right of the beam or from the right of the beam to the left of the beam with respect to the beam continuously irradiated from the ultrasonic sensor of the single channel, the operation sensing unit 110 may sense the lateral motion by the temporary disconnection of the beam. In addition, in the case where the user's hand moves to left-right-left of the beam or to right-left-right of the beam with respect to the beam continuously irradiated from the ultrasonic sensor of the single channel, the operation sensing unit 110 may sense the lateral repeat motion by repeating a temporary disconnection of the beam. Furthermore, in the case where the user's hand approaches the ultrasonic sensor of the single channel irradiating the beam and then moves away from the ultrasonic sensor of the single channel, based on the intensity of the beam continuously irradiated from the ultrasonic sensor of the single channel, or in the case where the user's hand moves away from the ultrasonic sensor of the single channel and then approaches the ultrasonic sensor of the single channel, based on the intensity of the beam continuously irradiated from the ultrasonic sensor of the single channel, the operation sensing unit 110 may sense the distance motion by using the fact that the signal strength of the ultrasonic sensor of the single channel changes depending on the proximity state.

The operation sensing unit 110 of the contactless gesture recognition system 100 according to an embodiment of the inventive concept may sense a contactless gesture operation by activating the ultrasonic sensor of the single channel after recognizing the user's proximity using a low power passive infrared ray (PIR) sensor.

For example, the contactless gesture recognition system 100 according to an embodiment of the inventive concept may include a low power PIR sensor and may activate the ultrasonic sensor of the single channel after sensing the proximity according to the user's movement from the low power PIR sensor. In this case, the low power PIR sensor may be a sensor that utilizes the pyroelectric effect in which electromotive force is generated due to the polarization change in a material when the infrared ray is absorbed, and may detect the far-infrared ray difference between the surrounding environment and an object (or person or the like) generating the far-infrared ray to detect the motion of the user.

The contactless gesture recognition system 100 according to an embodiment of the inventive concept may also use a low power Piezo Micromachined Ultrasonic Transducer (pMUT) ultrasound without a PIR sensor for an ultra-small size and low power, at mobile installation. For example, the low power pMUT ultrasound may be separated into a transmitting module and a receiving module, which are composed of a plurality of cells, in ultrasonic transmission and reception, and may be applied to an elevator switch or the like.

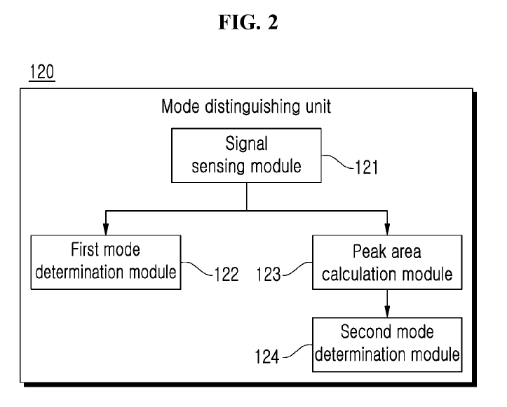

Hereinafter, the mode distinguishing unit 120 will be described in detail with reference to FIG. 2.

FIG. 2 illustrates a block diagram of a detailed configuration of a mode distinguishing unit, according to an embodiment of the inventive concept.

Referring to FIG. 2, the mode distinguishing unit 120 according to an embodiment of the inventive concept may distinguish a lateral mode and a cover mode by analyzing a detection signal sensed from the ultrasonic sensor of a single channel by a contactless gesture operation.

To this end, the mode distinguishing unit 120 according to an embodiment of the inventive concept may include a signal sensing module 121, a first mode determination module 122, a peak area calculation module 123, and a second mode determination module 124.

The signal sensing module 121 may sense the signal change of the detection signal caused by the contactless gesture operation.

For example, the signal sensing module 121 may sense the signal change of the occurrence of a falling peak with time, the number of falling peaks, and the area, based on the succession, disconnection, and signal intensity of the beam, which is irradiated from the ultrasonic sensor of a single channel, by the contactless gesture operation. At this time, the signal sensing module 121 may sense a single falling peak according to the contactless gesture operation of each of the lateral motion and the distance motion and may sense a plurality of falling peaks according to the contactless gesture operation of the lateral repeat motion.

For example, the first mode determination module 122 of the mode distinguishing unit 120 may determine the lateral mode and the cover mode based on the detected signal sensed from the signal sensing module 121 and the vibration graph change indicating a preset fixed value. At this time, the preset setting fixed value may be a preset value for distinguishing the lateral motion and the distance motion, and is not limited because the preset setting fixed value can be changed by a user or an administrator.

For example, the first mode determination module 122 may determine the lateral mode according to the contactless gesture operation of the lateral motion or the cover mode according to the contactless gesture operation of the distance motion, based on the setting fixed value and whether the falling peak generated depending on the signal change is repeated. In detail, in the case where the falling peak of the detection signal generated by the preset setting fixed value and the contactless gesture operation occurs repeatedly, the first mode determination module 122 may determine the lateral mode according to the contactless gesture operation of the lateral motion or the lateral repeat motion. On the other hand, in the case where the preset setting fixed value and the falling peak are not generated in the detection signal, the first mode determination module 122 may determine the cover mode according to the contactless gesture operation of the distance motion.

For another example, the peak area calculation module 123 of the mode distinguishing unit 120 may calculate the area of the falling peak according to the signal change sensed from the signal sensing module 121.

For example, for the purpose of distinguishing the lateral motion and the distance motion according to the sensed falling peak, the peak area calculation module 123 may calculate the area of the falling peak per period from Equation 1 below and may obtain the calculated area corresponding to the specific number of monitoring samples.

Area of a falling peak per period=sample period×distance Equation 1

Afterwards, the second mode determination module 124 may compare the calculated area value with the preset critical value to determine the lateral mode and the cover mode.

For example, when the area value calculated from the peak area calculation module 123 is less than the preset critical value, the second mode determination module 124 may determine the lateral mode according to the contactless gesture operation of the lateral motion; when the area value calculated from the peak area calculation module 123 is greater than the preset critical value, the second mode determination module 124 may determine the cover mode according to the contactless gesture operation of the distance motion. At this time, the preset critical value is an arbitrary value set to distinguish the lateral mode according to the lateral motion and the cover mode according to the distance motion, and thus is not limited.

Returning to FIG. 1, the control unit 130 of the contactless gesture recognition system 100 according to an embodiment of the inventive concept may control the contactless interface function corresponding to the lateral mode and the cover mode.

At this time, the control unit 130 may control the contactless interface function of mode conversion corresponding to the lateral mode and may control the contactless interface function of amount adjustment corresponding to the cover mode.

For example, the control unit 130 may add the contactless interface function of at least one or more of operation on/off, amount adjustment, mode conversion, page turning, zoom-in/zoom-out, cursor control, scroll control, tab, character control, button input, data transmission, screen switching, and data switching, which correspond to each of the lateral mode (the lateral motion and the lateral repeat motion) or the cover mode. However, the contactless interface function is variously changed depending on a device and a system, which include the contactless gesture recognition system 100 according to an embodiment of the inventive concept, and thus is not limited thereto.

Moreover, the control unit 130 may control the operation of the first mode determination module 122 of the mode distinguishing unit 120 that determines a mode by using a vibration graph change based on the signal change sensed from the detection signal or may control the operation of the second mode determination module 124 of the mode distinguishing unit 120 that determines a mode by using a mode algorithm.

For example, in the case where the signal change and the vibration graph change indicating the preset setting fixed value are clear based on the signal change sensed from the signal sensing module 121, the control unit 130 may control the first mode determination module 122 to determine the lateral mode and the cover mode.

On the other hand, in the case where it is impossible to distinguish the lateral mode and the cover mode through the first mode determination module 122 or in the case where the accuracy is low (e.g., in the case where the accuracy of the determination result is less than 70%), the control unit 130 may control the peak area calculation module 123 and the second mode determination module 124 to determine the lateral mode and the cover mode.

For another example, the contactless gesture recognition system 100 according to an embodiment of the inventive concept may determine the lateral mode and the cover mode through the determination module set by an administrator and may control the first mode determination module 122 and the second mode determination module 124 to operate at the same time. However, according to an embodiment, the first mode determination module 122 and the second mode determination module 124 may be set or controlled to determine the lateral mode and cover mode using a more efficient determination module of the first mode determination module 122 and the second mode determination module 124, based on the power or environment of a device and a system, which include the contactless gesture recognition system 100 of the inventive concept.

According to an embodiment, the contactless gesture recognition system 100 according to an embodiment of the inventive concept may further include an ultrasonic transducer, an analog-digital converter (ADC), components of a microcomputer in addition to a component illustrated in FIGS. 1 and 2.

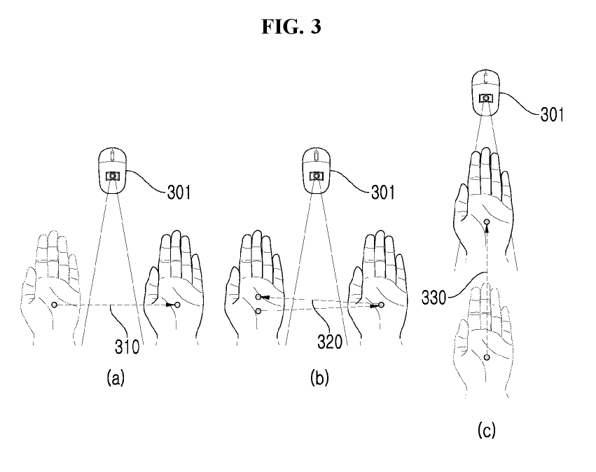

FIG. 3 is a view for describing an example of a contactless gesture operation, according to an embodiment of the inventive concept.

Referring to FIG. 3, the inventive concept may sense a contactless gesture operation of a user's lateral motion 310, a lateral repeat motion 320, and a distance motion 330, by using an ultrasonic sensor 301 of a single channel. In this case, the ultrasonic sensor 301 of the single channel may be an ultrasonic sensor of a single channel (1 channel), and may be an ultrasonic sensor including 1 channel transmission and 1 channel reception, in which transmission and reception are separated from each other, or an ultrasonic sensor including 1 channel transmission and reception, in which transmission and reception are coupled to each other.

In detail, referring to (a) of FIG. 3, in the case where the user's hand moves from the left of the beam to the right of the beam or from the right of the beam to the left of the beam with respect to the beam continuously irradiated from the ultrasonic sensor 301 of the single channel, a contactless gesture recognition system according to an embodiment of the inventive concept may sense the lateral motion 310 according to a temporal disconnection phenomenon of the beam irradiated from the ultrasonic sensor 301 of the single channel and may distinguish a lateral mode according to the contactless gesture operation of the lateral motion 310.

In addition, referring to (b) of FIG. 3, in the case where the user's hand moves from the left of the beam to the right of the beam and then moves to the left with respect to the beam continuously irradiated from the ultrasonic sensor 301 of the single channel, or in the case where the user's hand moves from the right of the beam to the left of the beam and then moves to the right with respect to the beam continuously irradiated from the ultrasonic sensor 301 of the single channel, a contactless gesture recognition system according to an embodiment of the inventive concept may sense the lateral repeat motion 320 according to repetition of the temporal disconnection phenomenon and the continuous phenomenon of the beam irradiated from the ultrasonic sensor 301 of the single channel and may distinguish the lateral mode (or referred to as a ‘lateral repeat mode’) according to the contactless gesture operation of the lateral repeat motion 320.

Furthermore, referring to (c) of FIG. 3, in the case where the user's hand approaches the ultrasonic sensor 301 of the single channel and then moves away from the ultrasonic sensor 301 of the single channel with respect to the location of the ultrasonic sensor 301 of the single channel, or in the case where the user's hand moves away from the ultrasonic sensor 301 of the single channel and then approaches the ultrasonic sensor 301 of the single channel with respect to the location of the ultrasonic sensor 301 of the single channel, the contactless gesture recognition system according to an embodiment of the inventive concept may sense the distance motion 330 based on the signal intensity changed depending on a proximity state of the ultrasonic sensor 301 of the single channel and may distinguish the cover mode according to the contactless gesture operation of the distance motion 330.

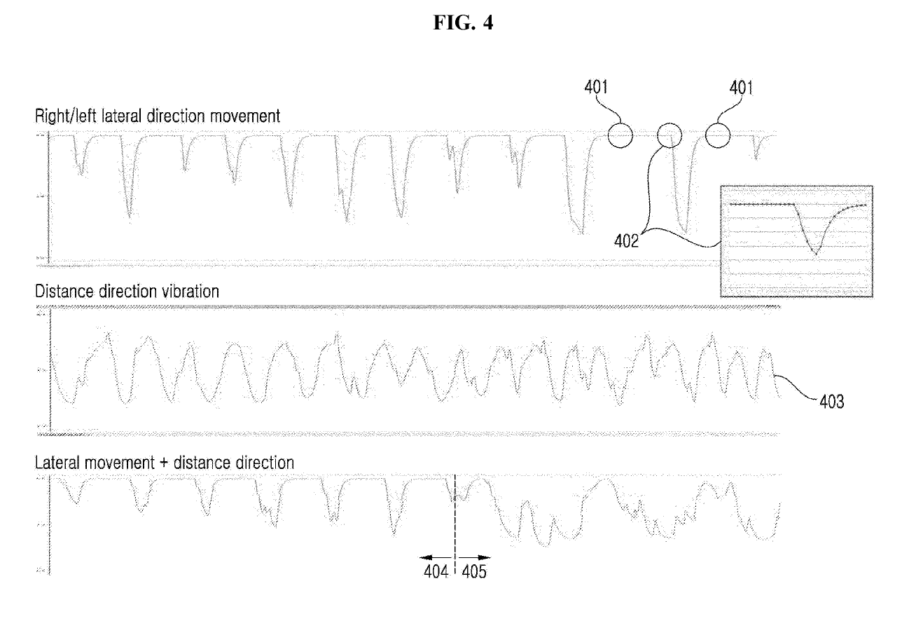

FIG. 4 is a view for describing an example to distinguish a lateral motion and a distance motion based on a signal change, according to an embodiment of the inventive concept.

Referring to FIG. 4, the upper graph of FIG. 4 shows the vibration graph change according to the lateral motion moving from left to right with respect to the ultrasonic sensor of single channel; the intermediate graph in FIG. 4 shows the vibration graph change according to the distance motion that approaches the ultrasonic sensor of the single channel and then moves away from the ultrasonic sensor of the single channel. In addition, the lower graph of FIG. 4 shows the vibration graph change in the case where both the lateral motion and the distance motion occur.

Referring to the upper graph of FIG. 4, a setting fixed value 401 and an abrupt change interval 402 are verified in the vibration graph change. At this time, the abrupt change interval 402 may be caused by a contactless gesture operation of a lateral motion or a lateral repeat motion, and may indicate a falling peak. That is, in the case where setting fixed value 401—abrupt change interval 402—setting fixed value 401 are continuously displayed as shown in the upper graph of FIG. 4, a contactless gesture operation of the lateral motion that moves from left to right, or from right to left may be detected.

Referring to the intermediate graph of FIG. 4, it is possible to refer to a vibration graph change 403 in which the setting fixed value 401 and the abrupt change interval 402 are not clear. That is, as illustrated in the intermediate graph of FIG. 4, in the case where the setting fixed value 401 and the abrupt change interval 402 are absent, the inventive concept may sense a contactless gesture operation of the distance motion that approaches the ultrasonic sensor of the single channel and then moves away from the ultrasonic sensor of the single channel.

Referring to the lower graph of FIG. 4, the contactless gesture recognition system according to an embodiment of the inventive concept may sense the continuity and variability of the contactless gesture operation based on graph 404 of the lateral motion and graph 405 of the distance motion and thus may sense the operation variation of the contactless gesture operation of the lateral motion and the contactless gesture operation of the distance motion.

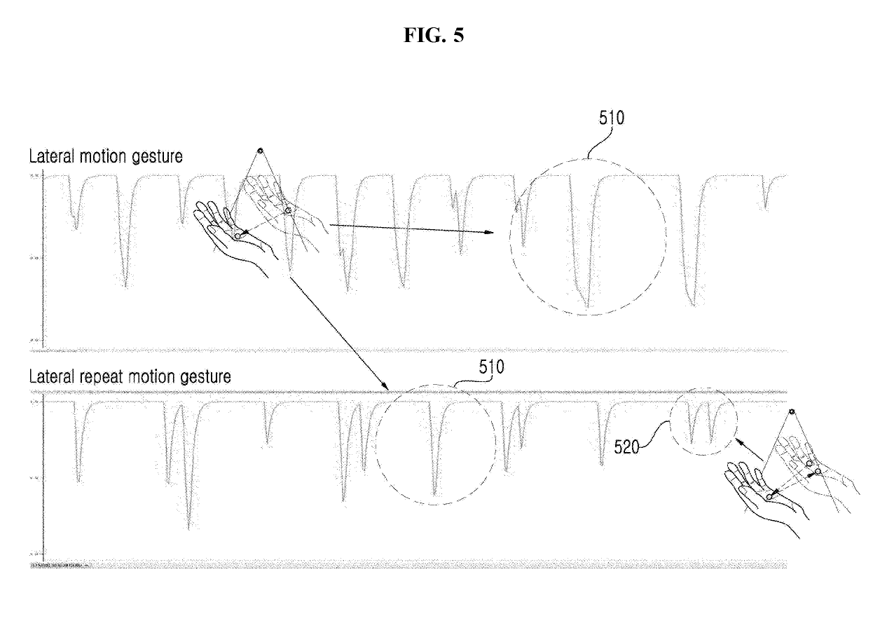

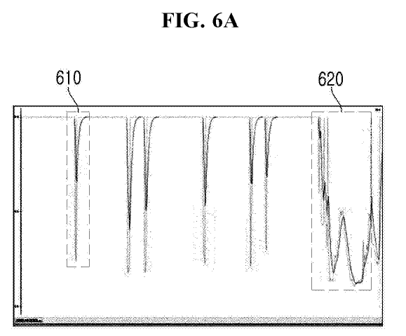

FIG. 5 is a view for describing an example to distinguishing a lateral motion and a lateral repeat motion based on a signal change, according to an embodiment of the inventive concept.

Referring to FIG. 5, in the case of a lateral motion in which a user's hand moves from left to right or from right to left with respect to the beam irradiated from an ultrasonic sensor of a single channel, one falling peak 510 appears on a detection signal.

Furthermore, in the case of a lateral motion in which the user's hand moves from the left of the beam to the right of the beam and then moves to the left of the beam with respect to the beam irradiated from an ultrasonic sensor of a single channel, or in the case of a lateral motion in which the user's hand moves from the right of the beam to the left of the beam and then moves to the right of the beam with respect to the beam irradiated from an ultrasonic sensor of a single channel, two falling peaks 520 appears on the detection signal.

Accordingly, the contactless gesture recognition system according to the embodiment of the inventive concept may sense and distinguish the lateral motion and the lateral repeat motion based on the number falling peaks and the type of the falling peak on the detection signal sensed depending on the contactless gesture operation.

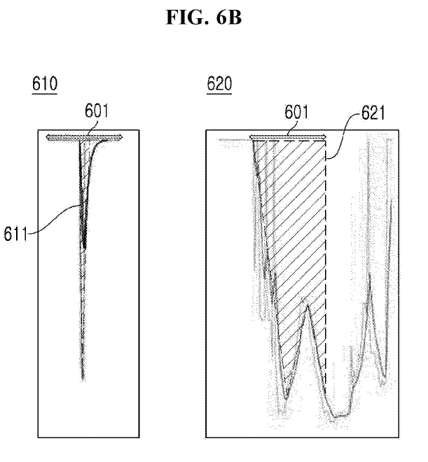

FIGS. 6A and 6B are views for describing an example to distinguish a lateral motion and a distance motion by calculating an area of a falling peak, according to an embodiment of the inventive concept.

In detail, FIG. 6A shows an example of a signal change of a detection signal caused by a contactless gesture operation, and FIG. 6B shows an example to calculate an area of a falling peak generated depending on a signal change.

Attorney Docket No. 5432.003

Referring to FIG. 6A, a contactless gesture recognition system according to an embodiment of the inventive concept may sense a first falling peak 610 and a second falling peak 620 in a detection signal generated by a contactless gesture operation.

At this time, for the purpose of determining a lateral mode or a cover mode from the first falling peak 610 and the second falling peak 620, the contactless gesture recognition system according to an embodiment of the inventive concept may calculate the area of a falling peak as shown in FIG. 6B.

For example, the contactless gesture recognition system according to an embodiment of the inventive concept may calculate an area 611 of the first falling peak for the first falling peak 610 and may calculate an area 621 of the second falling peak for the second falling peak 620. At this time, the area 611 or 621 of the falling peak may be calculated according to the above-described Equation 1, and may be calculated so as to correspond to the specific number of monitoring samples as an area per period.

That is, the contactless gesture recognition system according to an embodiment of the inventive concept may compare each of the calculated area 611 of the first falling peak and the calculated area 621 of the second falling peak with a preset critical value to determine the lateral mode and the cover mode.

For example, the contactless gesture recognition system according to an embodiment of the inventive concept may compare each of the calculated area 611 of the first falling peak and the calculated area 621 of the second falling peak with the preset critical value; since the comparison result indicates that the calculated area 611 of the first falling peak is less than the preset critical value, the inventive concept may sense that the first falling peak 610 is generated by the contactless gesture operation of the lateral motion and may determine the lateral mode according to the first falling peak 610.

Furthermore, the inventive concept may further apply a two-step determination process for more accurate determination of lateral motion. For example, in the case where the calculated area 611 of the first falling peak is less than the preset critical value (e.g., critical value 1) in the first step, the contactless gesture recognition system may compare preset critical value 2 with an initial value change rate of the first falling peak 610 in the second step. Afterwards, in the case where the initial value change rate of the first falling peak 610 according to the comparison result is greater than preset critical value 2, the contactless gesture recognition system may sense that the first falling peak 610 is generated by the contactless gesture operation of the lateral motion and may determine the lateral mode according to the first falling peak 610.

For another example, the contactless gesture recognition system according to an embodiment of the inventive concept may compare each of the calculated area 611 of the first falling peak and the calculated area 621 of the second falling peak with the preset critical value; since the comparison result indicates that the calculated area 621 of the second falling peak is greater than the preset critical value, the inventive concept may sense that the second falling peak 620 is generated by the contactless gesture operation of the distance motion and may determine the cover mode according to the second falling peak 620.

However, the preset critical value (including critical value 1 and critical value 2) is a value set to distinguish the lateral motion and the distance motion, and is not limited because the preset critical value can be changed by a user or an administrator.

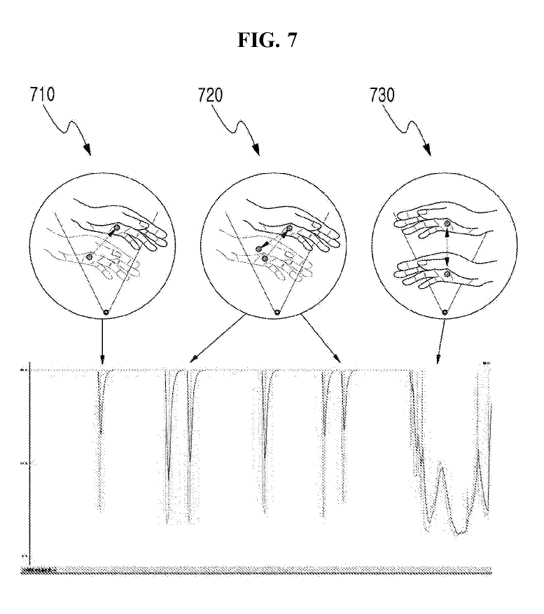

FIG. 7 illustrates an example of decoupling according to a contactless gesture operation, according to an embodiment of the inventive concept.

Referring to FIG. 7, a contactless gesture recognition system according to an embodiment of the inventive concept may sense a lateral motion 710, a lateral repeat motion 720, and a distance motion 730 based on the signal change of the detection signal generated by a contactless gesture operation, may determine a lateral mode according to the sensed lateral motion 710 and the sensed lateral repeat motion 720, and may determine a cover mode according to the sensed distance motion 730.

Afterwards, the contactless gesture recognition system according to an embodiment of the inventive concept may control a contactless interface function corresponding to each of the determined lateral mode and the determined cover mode.

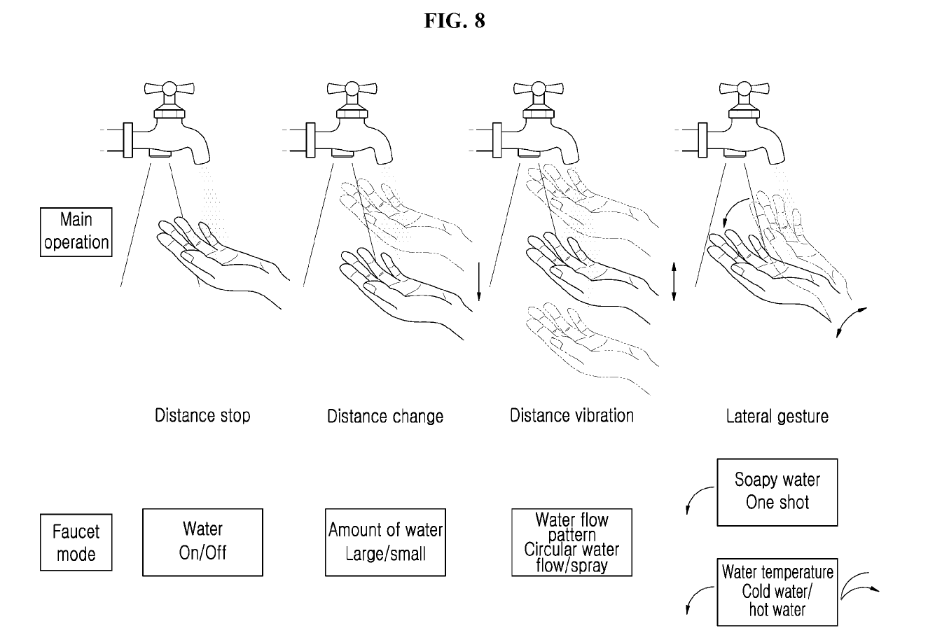

Hereinafter, the contactless interface function applied depending on a device including the inventive concept and a system including the inventive concept will be described in detail with reference to FIGS. 8 to 10.

FIGS. 8 to 10 illustrate examples of a contactless interface function.

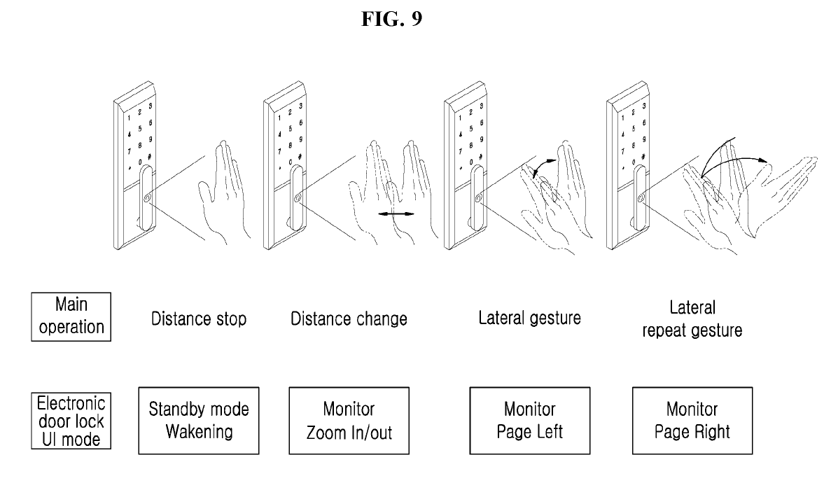

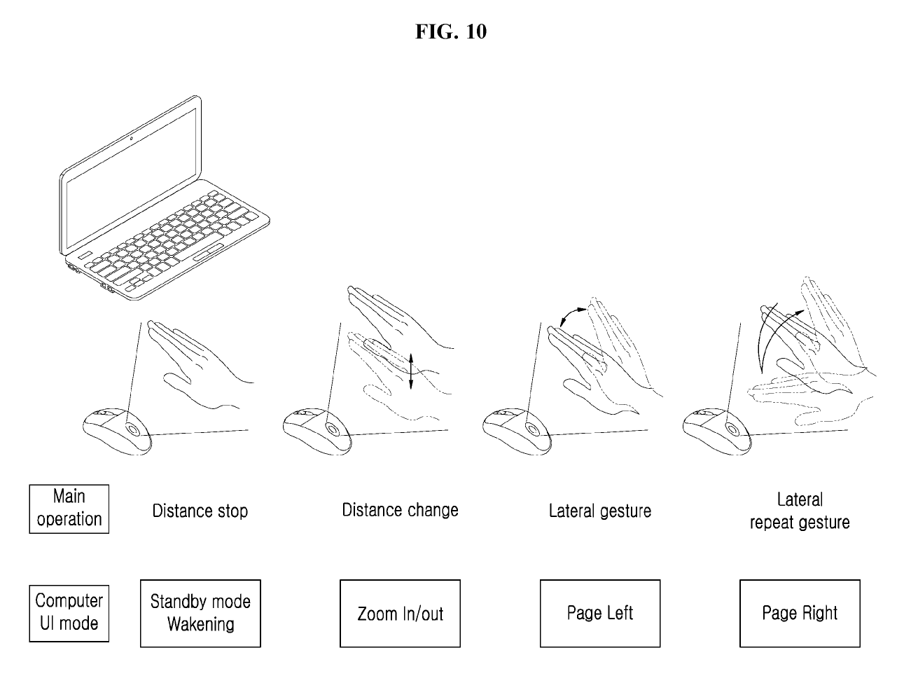

In more detail, FIG. 8 illustrates an example of the provided contactless interface function in the case where the inventive concept is applied to an auto faucet. FIG. 9 illustrates an example of the provided contactless interface function in the case where the inventive concept is applied to an electronic door lock. FIG. 10 illustrates an example of the provided contactless interface function in the case where the inventive concept is applied to a PC mouse.

Referring to FIG. 8, in the case where a specific distance from an ultrasonic sensor of a single channel to a part of a user's body is maintained, a contactless gesture recognition system according to an embodiment of the inventive concept applied to an auto faucet may turn on/off the operation of the auto faucet.

Moreover, the contactless gesture recognition system according to an embodiment of the inventive concept may control the amount of water depending on the distance change motion in which the user's hand approaches the ultrasonic sensor of the single channel included in the auto faucet or moves away from the ultrasonic sensor of the single channel and may control the water flow pattern depending on the repetition of the vibration of a distance motion.

Furthermore, the contactless gesture recognition system according to an embodiment of the inventive concept may control the operation of soapy water or may control the water temperature, depending on the lateral motion, which moves from left to right or from right to left with respect to the ultrasonic sensor of the single channel, and the lateral repeat motion that move to left-right-left or right-left-right with respect to the ultrasonic sensor of the single channel.

Referring to FIG. 9, in the case where a specific distance from an ultrasonic sensor of a single channel to a part of the user's body is maintained, a contactless gesture recognition system according to another embodiment of the inventive concept applied to an electronic door lock may activate a wakening mode.

Moreover, the contactless gesture recognition system according to another embodiment of the inventive concept may zoom in/out a monitor depending on the distance motion in which the user's hand approaches the ultrasonic sensor of the single channel included in the electronic door lock or moves away from the ultrasonic sensor of the single channel.

Furthermore, the contactless gesture recognition system according to another embodiment of the inventive concept may control a left page switch on the monitor depending on the lateral motion, which moves from left to right or from right to left with respect to the ultrasonic sensor of the single channel, and may control a right page switch on the monitor depending on the lateral repeat motion that move to left-right-left or right-left-right.

Referring to FIG. 10, in the case where a specific distance from an ultrasonic sensor of a single channel to a part of the user's body is maintained, a contactless gesture recognition system according to another embodiment of the inventive concept applied to a PC mouse may activate a wakening mode.

Moreover, the contactless gesture recognition system according to another embodiment of the inventive concept may zoom in/out a PC monitor depending on the distance motion in which the user's hand approaches the ultrasonic sensor of the single channel included in the PC mouse or moves away from the ultrasonic sensor of the single channel.

Furthermore, the contactless gesture recognition system according to another embodiment of the inventive concept may control a left page switch on the PC monitor depending on the lateral motion, which moves from left to right or from right to left with respect to the ultrasonic sensor of the single channel, and may control a right page switch on the PC monitor depending on the lateral repeat motion that move to left-right-left or right-left-right.

That is, the contactless gesture recognition system according to an embodiment of the inventive concept described above with reference to FIGS. 8 to 10 may provide various contactless interface functions that correspond to not only a lateral motion, a lateral repeat motion, and a distance motion of the user, but also a stop motion, a distance change motion, and a distance vibration motion (vibration repetition of distance motion), respectively. Furthermore, the contactless gesture recognition system according to an embodiment of the inventive concept may be based on a lateral motion, a lateral repeat motion, and a distance motion, may sense detailed contactless gesture operations according to repetition in a basic motion, a distance change, a vibration change, and a location change, and may distinguish the modes according to the sensed contactless gesture operation to add various contactless interface functions.

Moreover, the contactless gesture recognition system is not limited to the contactless interface function shown in FIGS. 8 to 10, and may include various or new contactless interface functions depending on a device and a system, which include the inventive concept, and administrator settings.

Also, the contactless gesture recognition system according to the embodiment of the inventive concept may be applied to an IoT device, a smart refrigerator, a mobile, an elevator switch, and a robot, as well as an auto faucet, an electronic door lock, and a PC mouse. That is, the inventive concept may be applied to all devices, apparatuses, systems, and computer programs that provide an interface function in response to the user's selection input.

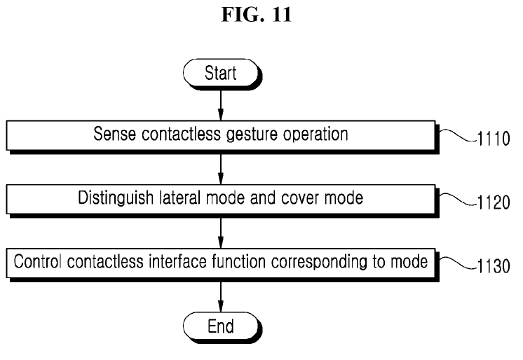

FIGS. 11 to 13 illustrate flowcharts of a contactless gesture recognizing method, according to an embodiment of the inventive concept.

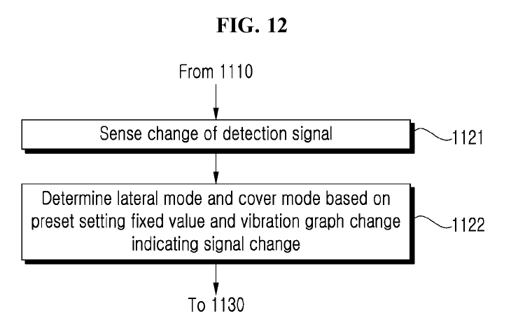

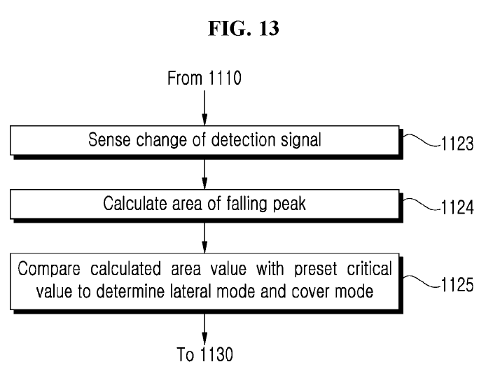

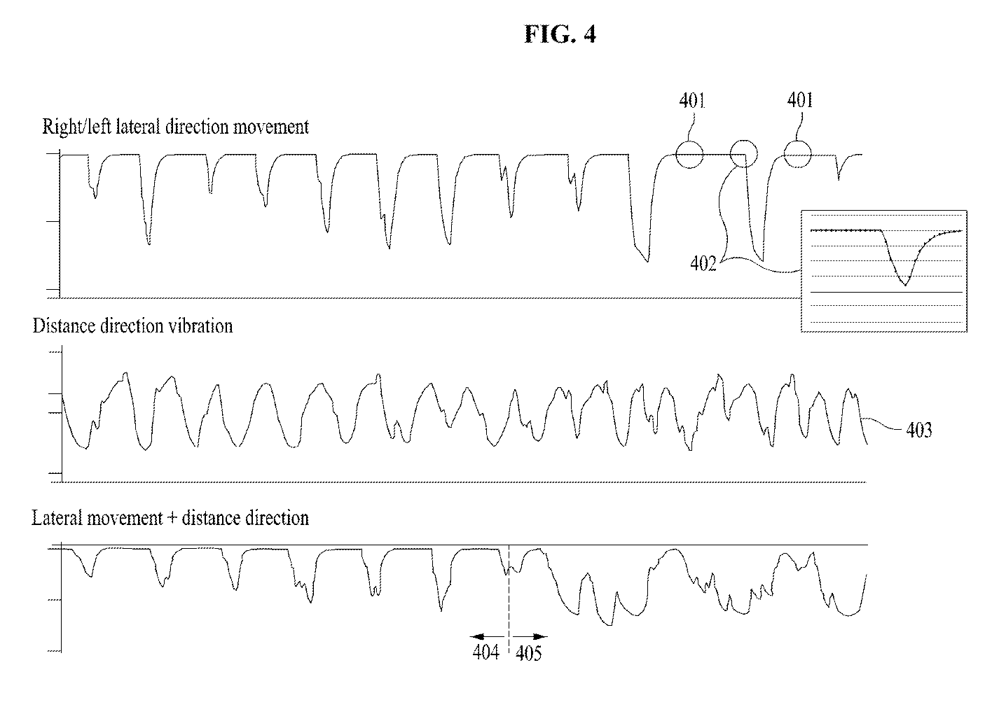

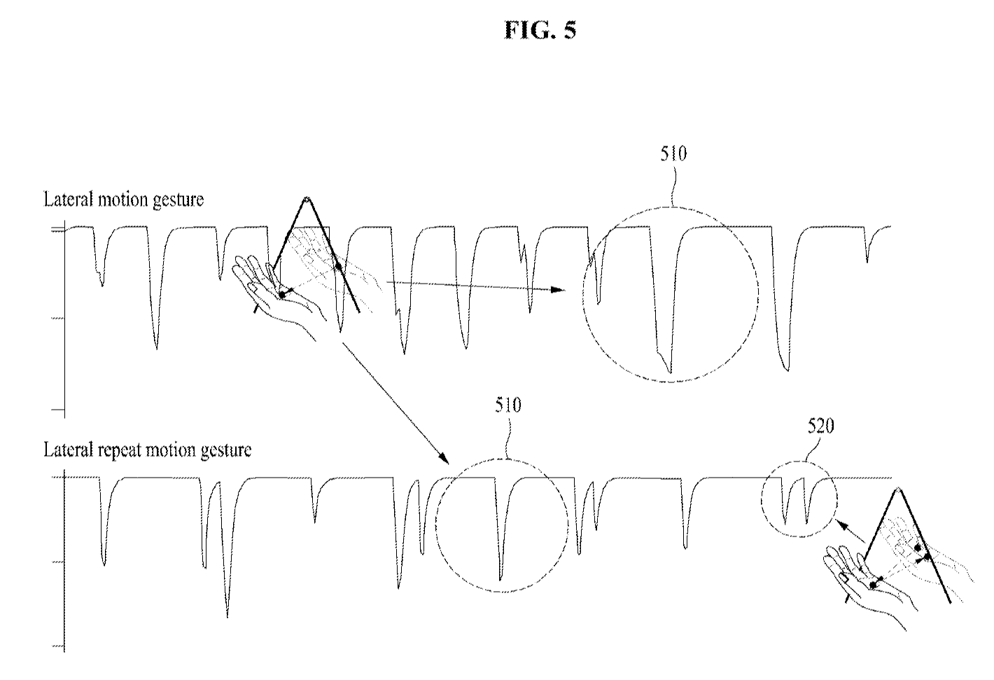

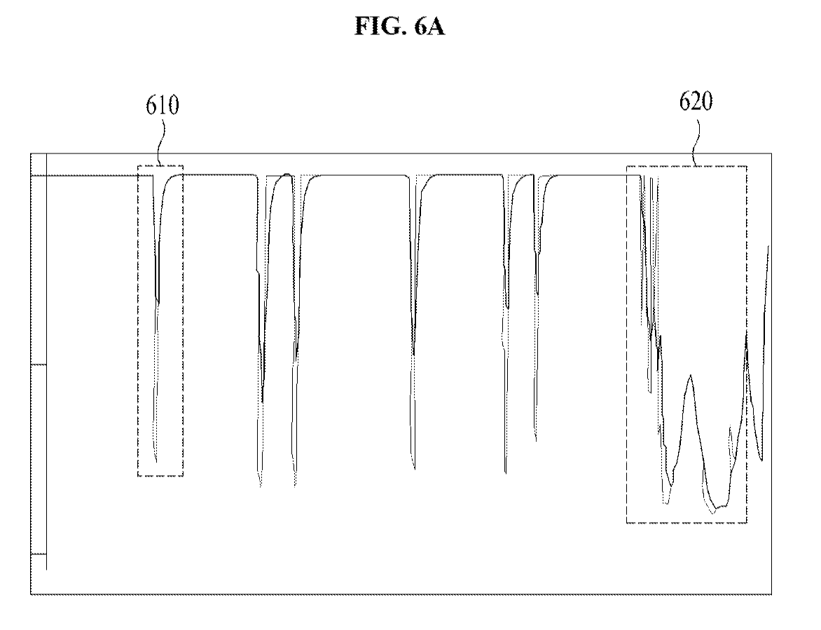

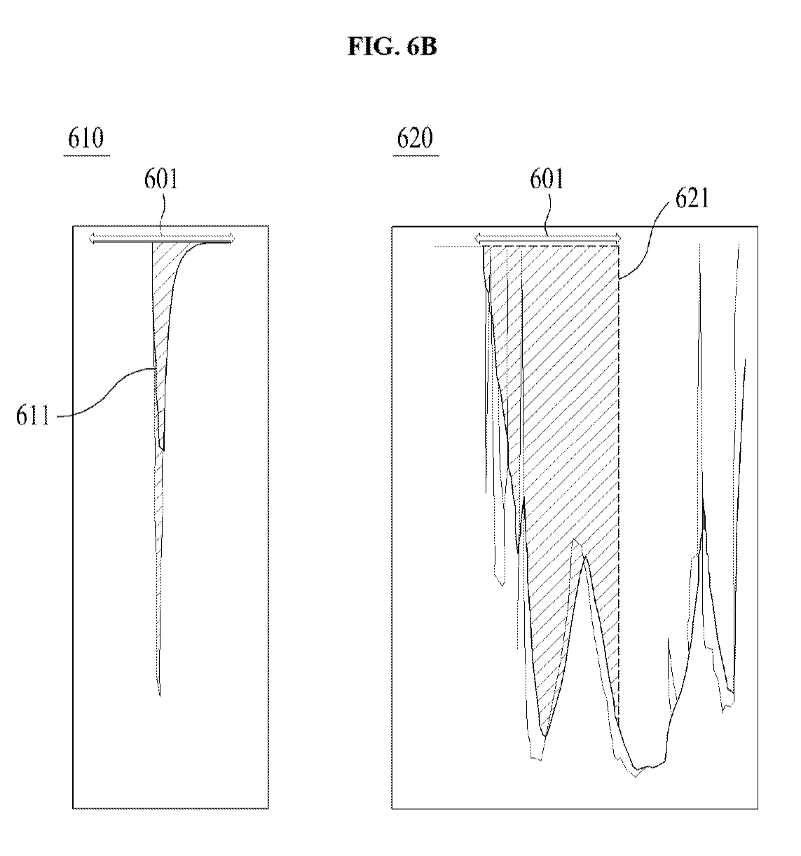

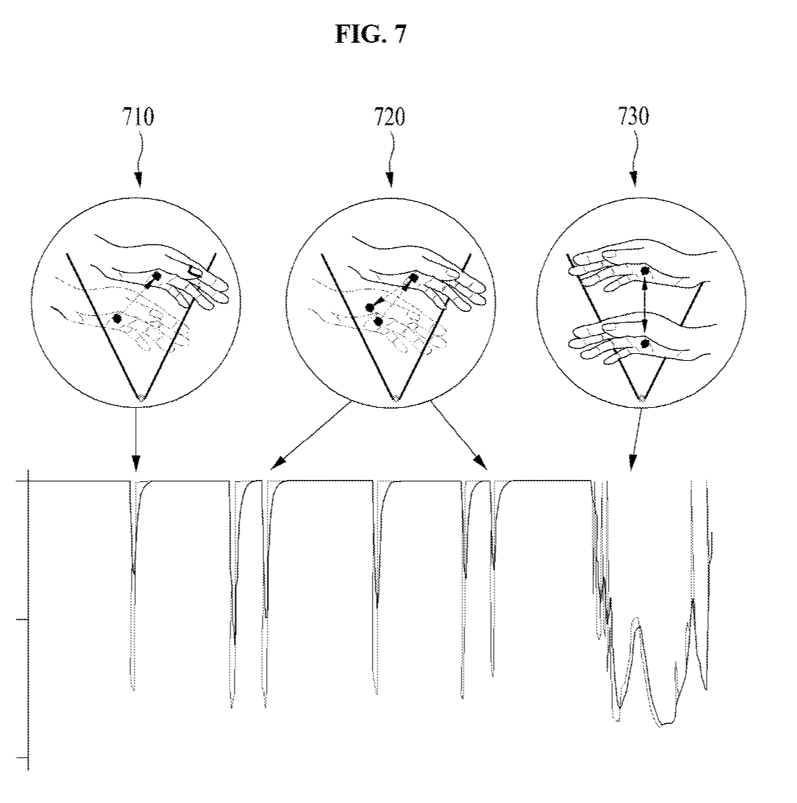

The methods illustrated in FIGS. 11 to 13 are performed by a contactless gesture recognition system according to an embodiment of the inventive concept illustrated in FIGS. 1 and 2. In more detail, the methods illustrated in FIGS. 12 and 13 may be performed by a mode distinguishing unit of the contactless gesture recognition system according to an embodiment of the inventive concept illustrated in FIG. 2.

Referring to FIG. 11, in operation 1110, the contactless gesture recognition system may sense a contactless gesture operation by using an ultrasonic sensor of a single channel.

In this case, the ultrasonic sensor of the single channel may be an ultrasonic sensor of a single channel (1 channel), and may be an ultrasonic sensor including 1 channel transmission and 1 channel reception, in which transmission and reception are separated from each other, or an ultrasonic sensor including 1 channel transmission and reception, in which transmission and reception are coupled to each other. However, the type of the ultrasonic sensor is not limited, and it is possible to use an ultrasonic sensor using a single channel.

For example, operation 1110 may be an operation of sensing a contactless gesture operation of a lateral motion, a lateral repeat motion, and a distance motion based on the succession and disconnection of the beam irradiated from the ultrasonic sensor of the single channel.

In operation 1120, the contactless gesture recognition system may analyze a detection signal sensed from the ultrasonic sensor of the single channel by the contactless gesture operation to distinguish a lateral mode and a cover mode.

For example, in operation 1121, the contactless gesture recognition system may sense the signal change of the detection signal caused by the contactless gesture operation.

For example, operation 1121 may be an operation of sensing the signal change of the occurrence of a falling peak with time, the number of falling peaks, and the area, based on the succession, disconnection, and signal intensity of the beam, which is irradiated from the ultrasonic sensor of a single channel, by the contactless gesture operation. Furthermore, in operation 1121, the contactless gesture recognition system may sense a single falling peak according to the contactless gesture operation of each of the lateral motion and the distance motion and may sense a plurality of falling peaks according to the contactless gesture operation of the lateral repeat motion.

Afterwards, in operation 1122, the contactless gesture recognition system may determine the lateral mode and the cover mode based on a preset setting fixed value and a vibration graph change indicating the signal change.

For example, operation 1122 may be an operation of determining the lateral mode and the cover mode based on the detected signal sensed from the signal sensing module 121 in operation 1121 and the vibration graph change indicating a preset fixed value. In detail, in operation 1122, in the case where the falling peak of the detection signal generated by the preset setting fixed value and the contactless gesture operation occurs repeatedly, the contactless gesture recognition system may determine the lateral mode according to the contactless gesture operation of the lateral motion or lateral repeat motion. On the other hand, in operation 1122, the contactless gesture recognition system may determine the cover mode according to the contactless gesture operation of the distance motion in the case where the preset setting fixed value and the falling peak are not generated in the detection signal.

For another example, in operation 1123, the contactless gesture recognition system may sense the signal change of the detection signal caused by the contactless gesture operation. At this time, in operation 1123, the contactless gesture recognition system may perform the same operation as operation 1121.

Afterwards, in operation 1124, the contactless gesture recognition system may calculate the area of a falling peak according to the signal change.

For example, for the purpose of distinguishing the lateral motion and the distance motion according to the sensed falling peak, operation 1124 may be an operation of calculating the area of the falling peak per period from above-described Equation 1 and of obtaining the calculated area corresponding to the constant number of monitoring samples.

Afterwards, in operation 1125, the contactless gesture recognition system may compare the calculated area value with the preset critical value to determine the lateral mode and the cover mode.

For example, operation 1125 may be an operation of determining the lateral mode according to the contactless gesture operation of the lateral motion when the area value calculated from the peak area calculation module 123 is less than the preset critical value and of determining the cover mode according to the contactless gesture operation of the distance motion when the area value calculated from the peak area calculation module 123 is greater than the preset critical value. At this time, the preset critical value is an arbitrary value set to distinguish the lateral mode according to the lateral motion and the cover mode according to the distance motion, and thus is not limited.

Returning to FIG. 11, in operation 1130, the contactless gesture recognition system may control the contactless interface function corresponding to each of the lateral mode and the cover mode.

For example, operation 1130 may be an operation of controlling the contactless interface function of mode conversion corresponding to the lateral mode and of controlling the contactless interface function of amount adjustment corresponding to the cover mode.

However, in operation 1130, the contactless gesture recognizing method according to an embodiment of the inventive concept may add and control the contactless interface function of at least one or more of operation on/off, amount adjustment, mode conversion, page turning, zoom-in/zoom-out, cursor control, scroll control, tab, character control, button input, data transmission, screen switching, and data switching, which correspond to each of the lateral mode (the lateral motion and the lateral repeat motion) or the cover mode. However, the contactless interface function is variously changed depending on a device and a system, which include the contactless gesture recognition system according to an embodiment of the inventive concept, and thus is not limited thereto.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A contactless gesture recognition system recognizing a 3-dimensional (3D) gesture, comprising:
an operation sensing unit configured to sense a contactless gesture operation by using an ultrasonic sensor of a single channel (1 channel);
a mode distinguishing unit configured to analyze a detection signal sensed from the ultrasonic sensor of the single channel by the contactless gesture operation to distinguish a lateral mode and a cover mode; and
a control unit configured to control a contactless interface function corresponding to each of the lateral mode and the cover mode.

2. The contactless gesture recognition system of claim 1, wherein the ultrasonic sensor of the single channel includes an ultrasonic sensor including 1 channel transmission and 1 channel reception, in which transmission and reception are separated, or an ultrasonic sensor including 1 channel transmission and reception, in which the transmission and the reception are coupled.

3. The contactless gesture recognition system of claim 1, wherein the operation sensing unit activates the ultrasonic sensor of the single channel to sense the contactless gesture operation after recognizing a user's proximity by using a low power passive infrared ray (PIR) sensor.

4. The contactless gesture recognition system of claim 1, wherein the operation sensing unit senses the contactless gesture operation of a lateral motion, a lateral repeat motion, and a distance motion based on succession and disconnection of a beam irradiated from the ultrasonic sensor of the single channel.

5. The contactless gesture recognition system of claim 1, wherein the mode distinguishing unit includes:
a signal sensing module configured to sense a signal change of the detection signal generated by the contactless gesture operation; and
a first mode determination module configured to determine the lateral mode and the cover mode based on a preset setting fixed value and a vibration graph change indicating the signal change.

6. The contactless gesture recognition system of claim 5, wherein the first mode determination module determines the lateral mode according to the contactless gesture operation of a lateral motion or the cover mode according to the contactless gesture operation of a distance motion, based on the setting fixed value and whether a falling peak generated depending on the signal change is repeated.

7. The contactless gesture recognition system of claim 1, wherein the mode distinguishing unit includes:
a signal sensing module configured to sense a signal change of the detection signal generated by the contactless gesture operation;
a peak area calculation module configured to calculate an area of a falling peak according to the signal change; and
a second mode determination module configured to compare a value of the calculated area with a preset critical value to determine the lateral mode and the cover mode.

8. The contactless gesture recognition system of claim 7, wherein the signal sensing module senses the signal change of an occurrence of the falling peak with time, the number of falling peaks, and the area, based on succession and disconnection of a beam, which is irradiated from the ultrasonic sensor of the single channel, by the contactless gesture operation.

9. The contactless gesture recognition system of claim 8, wherein the signal sensing module senses the single falling peak according to the contactless gesture operation of a lateral motion and a distance motion and senses the plurality of falling peaks according to the contactless gesture operation of a lateral repeat motion.

10. The contactless gesture recognition system of claim 9, wherein the peak area calculation module calculates the area of the falling peak for the sensed single falling peak by multiplying a sample period of the detection signal and a distance, to distinguish the lateral motion and the distance motion according to the sensed single falling peak.

11. The contactless gesture recognition system of claim 10, wherein the second mode determination module determines the lateral mode according to the contactless gesture operation of the lateral motion when the value of the calculated area is less than the preset critical value, and determines the cover mode according to the contactless gesture operation of the distance motion when the value of the calculated area is greater than the preset critical value.

12. The contactless gesture recognition system of claim 1, wherein the control unit controls the contactless interface function of a mode conversion corresponding to the lateral mode and controls the contactless interface function of amount adjustment corresponding to the cover mode.

13. The contactless gesture recognition system of claim 1, wherein the control unit controls a first mode determination module of the mode distinguishing unit that determines a mode by using a vibration graph change or controls a second mode determination module of the mode distinguishing unit that determines a mode by using a mode algorithm, based on a signal change sensed from the detection signal.

14. The contactless gesture recognition system of claim 1, wherein the contactless gesture recognition system includes a low power Piezo Micromachined Ultrasonic Transducer (pMUT) ultrasound for an ultra-small size and low power, at mobile installation.

15. The contactless gesture recognition system of claim 1, wherein the contactless gesture recognition system is applied to at least one of an auto faucet, an electronic door lock, an Internet of Things (IoT) device, a personal computer (PC) mouse, a smart refrigerator, a mobile and a switch to provide the contactless interface function.

16. An operation method of a contactless gesture recognition system recognizing a 3D gesture, the method comprising:
sensing a contactless gesture operation by using an ultrasonic sensor of a single channel (1 channel);
analyzing a detection signal sensed from the ultrasonic sensor of the single channel by the contactless gesture operation to distinguish a lateral mode and a cover mode; and
controlling a contactless interface function corresponding to each of the lateral mode and the cover mode.

17. The method of claim 16, wherein the distinguishing of the lateral mode and the cover mode includes: sensing a signal change of the detection signal generated by the contactless gesture operation; and
determining the lateral mode and the cover mode based on a preset setting fixed value and a vibration graph change indicating the signal change.

18. The method of claim 16, wherein the distinguishing of the lateral mode and the cover mode includes:
sensing a signal change of the detection signal generated by the contactless gesture operation;
calculating an area of a falling peak according to the signal change; and
determining the lateral mode when a value of the calculated area is less than a preset critical value or determining the cover mode when the value of the calculated area is greater than the preset critical value.

19. A computer program stored in a computer-readable storage media to perform a method of claim 16.
